(19) United States
(12) Patent Application Publication
(10) Pub. No.: US 2003/0158817 A1
(43) Pub. Date: Aug. 21, 2003

(54) System for permitting parcel sender to reassure parcel recipient

(76) Inventors: David C. Morris, New York, NY (US); Ivan D. Schwartz, Brooklyn, NY (US); Elliot S. Schwartz, New York, NY (US)

Correspondence Address: TIMOTHY E SIEGEL, 1868 KNAPPS ALLEY, SUITE 206, WEST LINN, OR, 97068, US

(21) Appl. No.: 10/078,594

(22) Filed: Feb. 19, 2002

(51) Int. Cl. G06F 17/60

(52) U.S. Cl. 705/64

(57) ABSTRACT

A method for permitting a parcel sender to permit a parcel recipient to verify that the parcel sender has registered identifying information about himself with an indicia-issuing entity. The method includes the steps of recording data about said parcel sender in a databank operated by said indicia-issuing entity and associating to said parcel sender an indicia wherein said indicia is verifiable as having been issued only by said issuing entity and associated to said parcel sender. In addition, a system of verification is made available to parcel recipients.

### BACKGROUND OF THE INVENTION

The recent occurrence of anthrax tainted mail incidents has directed the attention of the public to the lack of security in parcel delivery systems. It is a common experience to receive a parcel (the term “parcel”, as used in this application includes a simple envelope) from a sender unknown to the recipient. When this happens the recipient must either take a chance on discarding a parcel that may be harmless, well-intentioned and perhaps of great interest, or opening a parcel that contains a contaminant, a contaminant look-alike, or perhaps a bomb. For those in positions of importance in society, who receive mail from a great many sources, the problem is particularly difficult.

One societal response to the problem of tainted parcels has been for the United States Postal Service (USPS) to irradiate some or all of the mail going to key points, for example the nation's capital. Unfortunately, this approach is far from problem free. The process slows down the mail and may discolor or otherwise damage items. Some items, such as film, are particularly vulnerable to the irradiation process.

Unfortunately, it appears that there is currently no way for the well intentioned parcel sender to assure the intended recipient that he is not a menacing terrorist, prankster or other sort of wicked soul, bent on doing harm.

### SUMMARY

The present invention is a method for permitting a parcel sender to permit a parcel recipient to verify that the parcel sender has registered identifying information about himself with an indicia-issuing entity. The method includes, recording data about the parcel sender in a databank operated by the indicia-issuing entity, and issuing to the parcel sender an indicia wherein said indicia is verifiable as having been issued only by said indicia-issuing entity and as being associated to said sender and time of issuance. The indicia are physically associated to the parcel. In addition a system of indicia verification is made available to said parcel recipient. The foregoing and other objectives, features and advantages of the invention will be more readily understood upon consideration of the following detailed description of the preferred embodiment(s), taken in conjunction with the accompanying drawings.

### DETAILED DESCRIPTION OF THE PREFERRED EMBODIMENT

The present invention is a method by which a parcel recipient can be assured that, if necessary, it would be possible to identify the parcel sender. In the context of this application, the term “recipient” refers to anybody that receives the parcel, including any delivery or mail service that receives the parcel for the purpose of forwarding it to an ultimate recipient.

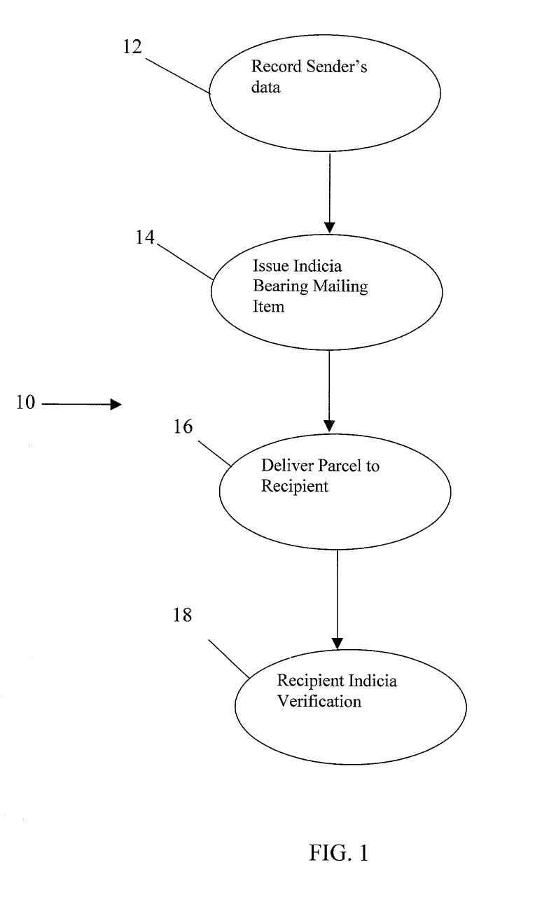

Referring to FIG. 1, in a preferred method 10 according to the present invention the parcel sender must register 12 with an indicia-issuing entity. In a first preferred embodiment, the parcel sender would only be required to submit his driver's license or some other item of photographic identification and a return address. In a second preferred embodiment, some biometric data would be taken, for example a photograph, a DNA sample, a fingerprint or a retinal map. At this point, the registered parcel sender would be issued a card, similar to an automated teller machine card and also a personal identification number. The parcel sender could also register as the employee of a corporation. Corporations would be responsible for registering mailing agents and for removing the registration when the mailing agent was no longer associated with the corporation.

After this the user could access any one of a set of machines that would be designed to issue indicia 14 bearing mailing items that would be indexed to that persons identity and to the time of issuance, upon entry of the card and the matching personal identification number. The indicia would also be sent to a central computer, so that it could be retrieved by a parcel recipient or by a parcel transporting company. The indicia bearing mailing items would be envelopes, return address labels or stickers, each bearing an indicia.

In a separate preferred embodiment the issued indicia would be coded, in a secret manner, to piece of information associated with the sender. For example, the indicia could be a function of the date and the sender's name and/or return address. In yet another preferred embodiment, the indicia would be indexed to the sender's private key, with the sender advising recipients of his public key.

The set of possible indicia is chosen so that many more possible indicia would be available then would ever be used. Fortunately it is very easy to derive an indicia scheme in which there is a far greater number of possible indicia than would ever need to be used. For example, using the ten numerals and 26 letters used in the English language, and having a 10-numeral or digit indicia, yields 3610 or 3.6 quadrillion indicia. Accordingly, if over the course of a year, one hundred billion indicia were issued at random, randomly chosen indicia would have only one chance out of about 30,000 of being one of the issued indicia. Therefore, if a wicked parcel sender were to try to circumvent the system by simply inventing indicia, his chances of success would be close to zero. Another indicia scheme could use the familiar bar code system. In yet another indicia scheme, a decodable graphic would be used. For example, an incomplete grid of dots, or an image in which certain colors appear at predetermined locations, could be easily decoded with the correct equipment.

The indicia bearing mailing item is then sent to a recipient 16. To verify 18 that the sender has registered identifying information at the issuing entity, a parcel receiver could access an indicia verification center maintained by the sending entity, typically in the form of a web site or telephone response system, and enter the indicia when prompted. The verification center, if appropriate, would verify the indicia and provide the name of the sender and the time of indicia issuance. Probably the most important reassurance is simply the indicia validity. If the indicia had been issued long before, however, a question would be raised about whether someone had observed the indicia on, perhaps, a discarded envelope and tried to reuse it. In addition to time stamping the indicia, a system of cancellation could be used for the indicia, either by the parcel transporting entity and/or recipients. For example, when the recipient verifies the indicia validity, this act could have the effect of canceling the indicia, so that it would no longer be considered valid.

In the embodiment in which the indicia were related in a secret manner to some aspect of the sender's information and the date sent, recipients would be supplied with decoding software for verifying the correctness of the indicia. Although this would raise the specter of a clever system defeater deciphering the secret relationship, one-way encryption/decryption techniques are used to make this virtually impossible. In addition, the system is changed periodically with new software distributed.

The problem of reprobates reading indicia from posted parcels is addressed in different ways by a number of preferred embodiments. In a first preferred embodiment, the indicia are printed in color, with a high level of resolution, so that a mailing item imitator would be hard pressed to print out a sufficiently accurate imitation. In another preferred embodiment, the indicia bearing mailing item includes a water mark, color design or some other difficult to reproduce image, along with the indicia. In yet another preferred embodiment, the indicia is indexed to both sender and intended recipient. This would stymie prospective wrong doers with a specific target or set of targets in mind, because that person would have to intercept or recover a parcel being sent to the target (for example a U.S. Senator) rather than intercepting any indicia bearing parcel. In addition, as noted above, a system of cancellations may be used to make more difficult the system circumventors task.

In another preferred embodiment, each sender would be issued a rule for deriving a set of numbers for each date. The rule could make use of a personal identification number (PIN). For example, a particular sender could be assigned a rule by which his PIN would be multiplied a number representing the date minus some multiple of 956. For example if the senders PIN was 3547 and the date was 1/15/2002, then 3547*(1,152,002−2*956)=4,079,369,230 would be an acceptable indicia. This is, of course, a very simple algorithm, and, if such a simple algorithm were used, it would have to be changed reasonably frequently. The recipient would verify the number with a central data bank that also would have the ability to apply the algorithm. The advantage of this system is that for the sender it does not require any trip to a special location to have a mailing item printed out. Rather the sender may easily find as many numbers as desired for any particular day.

In another embodiment, a sender could invent indicia and simply upload the invented indicia to the verification center, to be available for the recipients inquiry.

The system described here could be used by governmental mailing agencies, such as the United States Postal Service (USPS), or by private companies through a cooperative agreement with an indicia-issuing entity. Alternatively the USPS or a private company could issue their own indicia. When recipients access the web site to verify the indicia, this could be an advertising opportunity for mass parcel senders.

The terms and expressions that have been employed in the foregoing specification are used as terms of description and not of limitation. There is no intention, in the use of such terms and expressions, of excluding equivalents of the features shown and described or portions thereof, it being recognized that the scope of the invention is defined and limited only by the claims which follow.

1. A method for permitting a parcel sender to permit a parcel recipient to verify that the parcel sender has registered identifying information about himself with an indicia-issuing entity, that includes the steps of:
(a) recording data about said parcel sender in a databank operated by said indicia-issuing entity,
(b) associating to said parcel sender an indicia wherein said indicia is verifiable as having been issued only by said issuing entity and associated to said parcel sender;
(c) physically associating said indicia to a parcel; and
(d) providing said parcel recipient with a system for verifying the authenticity of said indicia.

2. The method of claim 1 wherein step (b) is accomplished by first issuing a card and personal identification number (PIN) to said sender and permitting said sender to access a machine which discloses indicia in response to input of said card and said PIN.

3. The method of claim 1 wherein step (b) is accomplished by issuing a mailing item bearing said indicia.

4. The method of claim 3 wherein said mailing item is an envelope.

5. The method of claim 3 wherein said mailing item is a label.

6. The method of claim 5 wherein said label is a return address label.

7. The method of claim 3 wherein said indicia bearing mailing item includes a design that is difficult to photocopy.

8. The method of claim 7 wherein said design is a watermark.

9. The method of claim 7 wherein said design is a detailed color design.

10. The method of claim 1 wherein said indicia is a bar code.

11. The method of claim 1 wherein said indicia is decodable graphic.

12. The method of claim 1 wherein a parcel delivery service regularly verifies and logs the indicia of parcels bearing indicia.

13. The method of claim 1 wherein said indicia are chosen at random.

14. The method of claim 1 wherein said indicia are chosen according to an algorithm.

15. The method of claim 1 wherein said system for verifying the authenticity of said indicia is a verification center, contactable by said recipient.

16. The method of claim 1 wherein said system for verifying the authenticity of said indicia is a decoding device provided to said parcel recipient.

17. The method of claim 16 wherein said decoding device provided to said parcel recipient is a computer program.

18. The method of claim 1 wherein said indicia are associated to a sender by being logged into a central data bank by said sender.
